(19) United States
(12) Patent Application Publication
(10) Pub. No.: US 2010/0279716 A1
(43) Pub. Date: Nov. 4, 2010

(54) Method and apparatus for the integration of SMS message communications into call center operation

(75) Inventors: David S. Benco, Winfield, IL (US); Deborah L. Barclay, Winfield, IL (US)

Correspondence Address: Docket Administrator - Room 3D-201E;Alcatel-Lucent USA Inc., 600-700 Mountain Avenue, Murray Hill, NJ, 07974, US

(73) Assignee: Alcatel-Lucent USA Inc., Murray Hill, NJ (US)

(21) Appl. No.: 12/387,367

(22) Filed: May 1, 2009

(51) Int. Cl. H04W 4/12

(52) U.S. Cl. 455/466

(57) ABSTRACT

A method and apparatus for efficiently integrating SMS (short message service) messages into distributed agent call center operation. A call center application server receives an SMS message from an SMS client, then identifies the sender of the received SMS message, determining whether an SMS session associated with the sender is currently open and, if so, identifying the current SMS session agent. If an SMS session associated with the SMS message sender is not currently open, the call center application server opens an SMS session and selects a current SMS session agent, thereafter routing the SMS call to the current SMS session agent. The SMS session will remain open until closed, for example upon receipt of an SMS session closure message from the current agent.

### TECHNICAL FIELD

The present invention relates generally to the field of telecommunications, and, more particularly, to a method and apparatus for efficiently integrating SMS (short message service) messages into call center operation.

### BACKGROUND

Call centers are in widespread use around the world. In a call center, a number of agents are employed to engage an expected volume of callers in communication sessions. In a typical scenario, business customers or other potential callers are provided with a single directory number for reaching a particular business unit or other service provider. These callers may expect, for example, to be able to reach someone who will provide technical assistance, answer questions, or take their order for a product. Other services may also be provided, such as responding to medical emergencies or dispatching police or fire fighters. Although each caller typically uses the single telephone number provided, calls received at a call center are routed to one of the many agents employed there. The agent may be a live operator or an automated device that can pose questions to a caller and receive responses, for example from a caller responding to recorded or synthesized-voice inquiries by speaking or pressing keys.

Calls are usually routed to agents based first on their availability, but frequently other factors are considered as well, such as the qualifications or experience level of an individual agent, or the perceived needs of the caller. As should be apparent, a goal of the call center is to respond to each caller without undue delay while employing as few agents as possible. When a call is routed to an agent, they remain unavailable until the communication session is ended. During that time, any calls received at the call center are routed to other agents, or simply placed on hold until a suitable agent becomes available.

Call centers have in some ways adjusted to improvements in communication technology, for example accommodating TTY (text telephony) telephone or video communications sessions. They are not able, however, to deal very effectively with SMS (short message service) messages. SMS messages are short text messages, typically sent by users of wireless mobile telephones. SMS messaging was developed to allow such messages to be sent over a wireless channel when it becomes available. The actual transmission time for an SMS message is very short, regardless of how long it took the sender to compose it. Unlike a typical voice call, communication channels for SMS messages are needed only for an instant and are not tied up for extended periods of time as they might be for voice calls.

Despite the limited message size, and the fact that SMS messages must often be composed using a standard telephone keypad, SMS texting has become very popular, especially among younger consumers. Wireless providers have responded by making the service more affordable, and now it is available to users of almost all mobile telephones, even the least expensive models. At the same time, users are becoming more proficient at composing SMS messages, adjusting to the fragmented nature of the medium, and discovering the advantages that SMS messages do offer. SMS messages can be sent to more than one recipient at a time, yet do not depend on any of them being available at the time when the message is sent. Recipients usually receive the SMS messages very quickly, but can respond, if at all, at their leisure. And SMS messages can be sent and received silently, without the need for audible conversation, a feature useful in many situations.

These advantages would make SMS messages ideal for communicating with call centers in some circumstances. Callers would not have to spend extended periods of time on hold when the call center is congested, and agents may actually be able to address the needs of more callers. In some cases, as with the need for provision of emergency services, for example, audible conversation may be undesirable or impracticable. Unfortunately, call center operation is not suitable for handling SMS message communication very efficiently. If a call center is able to receive SMS messages, each message would be routed to an available agent when it is received. The agent could respond, but is unlikely to satisfy the caller's expectation with a single response. Subsequent SMS messages from the caller may be routed to different agents, who would not be familiar with the preceding communications. At the same time, it would be highly undesirable for the agent to be otherwise unavailable until the SMS message transaction has been completed, which could consume quite a bit of elapsed time.

Accordingly, there has been and still is a need to address the aforementioned shortcomings and other shortcomings associated with integrating SMS communications into the call center environment. These needs and other needs are satisfied by the present invention.

### SUMMARY

The present invention is directed to more efficiently integrating SMS messaging into the call-center environment. In one aspect, the present invention is a method implemented by a call center application server for integrating SMS message communication into the call center environment, including opening an SMS session upon the receipt of an SMS message if there is not an open SMS session associated with the sender of the SMS message; assigning an agent to the SMS session when it is opened, and routing the received SMS message to the assigned agent. Opening an SMS session may include recording information related to the received SMS message, for example the identity of the SMS message sender, the time the SMS message was received, and the agent assigned to the SMS session. The method may further include determining that a received SMS message is from a sender associated with an open SMS session and retrieving the identity of the agent assigned to the open SMS session. When an agent is assigned to an SMS session, the method may include determining whether the agent assigned to an open SMS session is currently available and, if not, determining whether to assign a second agent to the SMS session. In some embodiments, the SMS message may be routed to both the second agent and the originally-assigned agent. In a preferred embodiment, the SMS session remains open until it is closed upon receipt of a closure message from an assigned agent.

In another aspect, the present invention is a method of handling SMS communications in a call center application server, including receiving an SMS message from an SMS client in the call center application server, identifying the sender of the received SMS message, determining whether an SMS session associated with the sender is currently open and, if so, identifying the current SMS session agent, if an SMS session associated with the sender is not currently open, opening an SMS session and selecting a current SMS session agent, and routing the SMS call to the current SMS session agent. The SMS session will remain open until closed, for example upon receipt of an SMS session closure message from the current agent.

In yet another aspect, the present invention is a call center application server, including a network interface for receiving SMS messages, an SMS message scanner coupled to the network interface for determining the identity of an SMS message sender, an SMS session database for storing data related to SMS message sessions, a processor for querying the SMS database to determine whether an SMS session associated with an SMS sender is currently open and, if so, identifying the current SMS session agent assigned to the open SMS session, an agent selector for selecting a current SMS session agent if there is no available current SMS session agent assigned to the SMS session, and an SMS message router for routing a received SMS message to the current SMS message agent associated with the SMS sender.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a schematic diagram illustrating selected components of a telecommunication system for implementing an embodiment of the present invention;

FIG. 2 is a flow diagram illustrating a method for integrating SMS message communication into the call center environment according to an embodiment of the present invention;

FIG. 3 is a flow diagram illustrating a method of handling SMS communications in a call center application server according to an embodiment of the present invention; and

FIG. 4 is a simplified block diagram illustrating selected components of an application server configured according to an embodiment of the present invention.

### DETAILED DESCRIPTION

The present invention is directed to more efficiently integrating SMS messaging into the call-center environment. As mentioned above, while present-day call centers may be able to receive and send SMS messages, in practice this has relatively-limited value. The present invention remedies this shortcoming in existing practice.

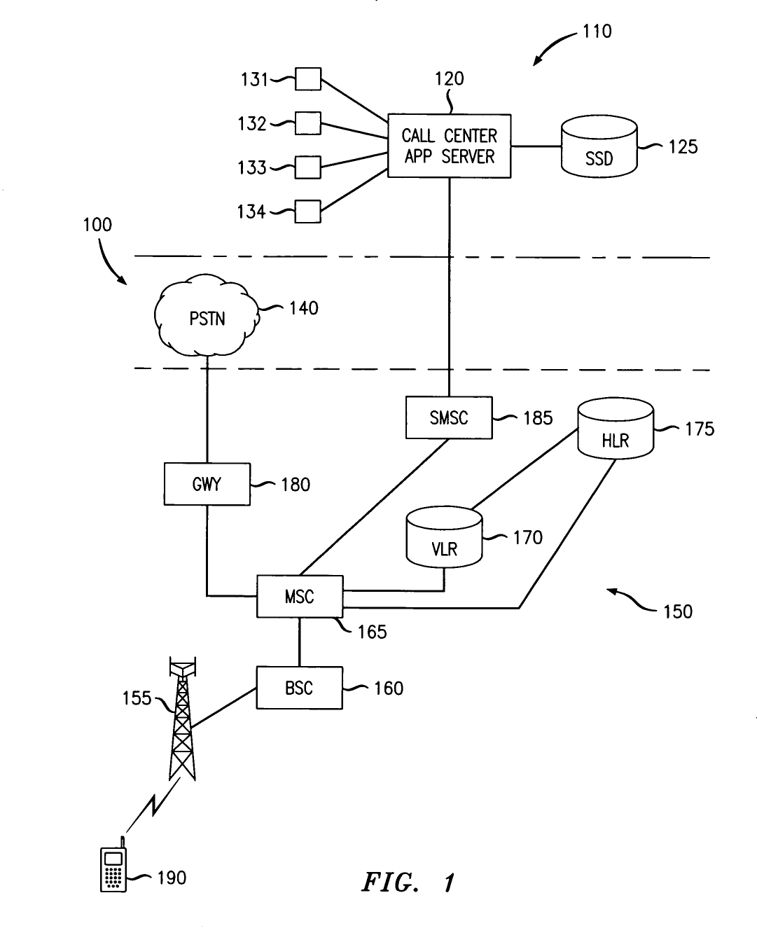

FIG. 1 is a schematic diagram illustrating selected components of a telecommunication system 100 for implementing an embodiment of the present invention. Telecommunication system 100 includes, in turn, selected components of a call center 110 and a wireless network 150, which in this exemplary configuration communicate with each other through PSTN (public switched telephone network) 140. PSTN 140 is representative of the typical wireline networks that have long been installed in many parts of the world. Prior to the deployment of wireless networks such as network 150, call center access was mainly through a PSTN. The numerous components of PSTN 140 are not shown in FIG. 1, but generally comprise a number of switching nodes interconnected in a hierarchical network enabling a communication channel circuit to be established, when needed, between any two (or more) subscriber telephones. Most PSTNs are also connected to each other through some kind of gateway node (not shown) so that subscribers of one network can also communicate with subscribers of another.

When a PSTN 140 subscriber (not shown) wishes to contact call center 110, they can simply pick up the phone and dial the call center's number; through PSTN 140, they will be connected to the call center application server 120 or an associated switch (not separately shown). Note that in FIG. 1, PSTN 140 is connected directly to application server 120. In other systems, communication between PSTN 140 and call center application server 120 may not be direct, but rather pass through an intermediate gateway or similar device.

As mentioned above, the subscriber may or may not be aware that they are calling a call center, but they are simply using a directory number that has somehow been provided to them. They may expect, for example, to be able to reach someone who will provide technical assistance, take their order for a product, or provide some other service. When the subscriber's call is terminated at the application server 120, however, the subscriber's call is routed to an available agent to provide one of these services. The call center application server preferably has the ability to answer many such calls and route them to an appropriate agent. In FIG. 1, the agents work at stations that are represented by blocks 131 through 134, although in most call centers there are a much larger number of agents.

As should be apparent, the call center application server has great utility in its ability to connect a relatively large number of callers with available agents. In this context, note that an agent may be a human being or an automated agent of some kind. In either case, however, the first key is that the agent is actually available. The caller may not care which agent provides a service to them, but they will almost certainly not want to be placed “on hold” for extended periods of time while the wait for an agent to become available. Although in some instances this may be unavoidable, the call center will usually want to be accommodating when possible.

This does mean that a subscriber who calls more than once my not be routed to the same agent each time. For many callers this may not be a disadvantage, and in some cases it will be preferred. At other times, however, callers may be able to request a particular agent and be transferred to them by the agent to whom the call is routed. In some circumstances, however, a caller will have to describe to a new agent what transpired in another session.

Many call centers do allow for outbound calls, that is, a call center may initiate the call to a subscriber. In some cases, this involves an agent calling a subscriber back via the PSTN 140, either with or without the need to route the call through call center application server 120 depending on how the call center is configured. In other cases, for example in an opinion poll or sales campaign, an outbound dialer (not separately shown) calls telephone customers. The PSTN 140 may also be used for this purpose. If and when a subscriber answers, the call center application server connects the call to an available agent. In this way, available agents do not have to wait for subscribers to answer the phone.

Mobile network customers may access call center 110 in similar fashion via wireless network 150. Again, only selected components of wireless network 150 are shown, though it will be described in some detail.

When the user of MS (mobile station) 190 wants to call the call center 110, they initiate the call in similar fashion to a wireline subscriber, such as by entering an appropriate telephone number. To set up the call, however, MS 190 must establish radio contact with a local antenna, one that communicates with MSs in the geographic are in which MS 190 is currently located. If there is no wireless antenna within range, the call cannot be initiated and the user will have to wait until service is available. In the embodiment of FIG. 1, this antenna belongs to BTS (base transceiver station) 155. In a typical wireless cellular network, there are a great many BTSs, though for simplicity only one is shown in FIG. 1. BTS 155 communicates with MS 190 over an air interface under the direction of BSC (base station controller) 160, which may control other BTSs (not shown) as well.

Like the PSTN 140, wireless network 150 comprises a number of switches that route calls from a calling party to a called party, or to some kind of gateway node bridging wireless network 150 to another network. In the embodiment of FIG. 1, BSC 160 is connected to MSC (mobile switching center) 165 for this purpose. Note again that although a typical wireless network may, and likely will have more than one MSC and BSC; only one of each device is shown for simplicity. When MS 190 initiates a call via BTS 155 and BSC 160, MSC 165 may consult VLR (visiting location register) 170, a database associated with MSC 165 or HLR (home location register) 175, a database associated with network 150 in general, for information about MS 190 and the party that they are trying to reach so that the call may be properly routed.

In the embodiment of FIG. 1, MSC 165 will route the call from MS 190 to call center 110 via gateway 180. Gateway 180 in turn provides access to PSTN 140, though which the call is completed to call center application server 120. Note that in other embodiments, the call may not be routed through PSTN 140, instead being routed another network or directly to call center application server 120. In addition, in some cases the call center may use a separate server for handling calls from the wireless network.

If an MS subscriber uses an SMS message to communicate with call center 120, it takes a different route. For one thing, SMS messages do not initiate a connection between a calling party and a called party. Instead, the MS may wait to send the SMS message until the air channels to BTS 155, or to another BTS if the mobile station relocates, is less congested. While this may delay transmission of the SMS message, it does have the advantage of automatically sending when a channel is available, rather than simply denying access to the user. (In contrast, blocked voice calls are not normally attempted again as soon as a channel is available, but rather require the user to re-initiate them.) As mentioned above, this may actually sometimes be an advantage associated with SMS messaging.

For example, after a natural disaster such as a hurricane, there may be many people trying to reach emergency service providers, while others try to locate friends and relatives. At the same time, the wireless network 150 and PSTN 140 may have suffered damage that significantly reduces their capacity. The fact that the SMS message takes a different route and can be sent whenever the transmission channel is next available may enable communication that would otherwise be difficult or impossible.

In this embodiment, when the SMS message does reach BTS 155 (or another BTS), it is relayed to BSC 160. BSC 160, in turn, forwards the SMS message to SMSC (short message service center) 185 via MSC 165. SMSC 185 then determines the destination for the SMS message, in this case, forwarding it to call center application server 120. SMSC 185 may be in direct communication with call center application server 120, as shown in FIG. 1, or alternately the SMS message may be routed through one or more additional nodes. The SMSC 185 may also store the SMS message until the call center application server 120 (and intervening nodes, if any) are able to receive it.

Note that in this embodiment, application service center 120 handles SMS messages as well as calls from the PSTN 140 and those (ultimately) from wireless network 150. The same of course would be true of calls from another network (not shown) that is in communication with either of PSTN 140 or wireless network 150. By the same token, SMS messages may be routed through SMSC 185, for example from another SMSC (also not shown). In other embodiments, however, different call center application servers may handle access by different networks, or in some cases multiple application servers may be used for a single network.

While received SMS messages may be routed to the next available agent (or qualified agent) just as phone calls are, in normal processing subsequently received SMS messages are routed in the same fashion. As a consequence, multiple SMS messages may be routed may be routed to different agents, even (or especially) if received over a relatively short time span. For this reason, application server 120 uses SMS session database 125 to efficiently integrate SMS messaging into the call center environment, a process that will now be explained in more detail. Note, however, that although illustrated as separate components call center application server 120 and SMS session database 125 may in some implementations reside in the same physical device.

FIG. 2 is a flow diagram illustrating a method 200 for integrating SMS message communication into the call center environment, according to an embodiment of the present invention. At START, it is presumed that the components necessary to performing this method are available and operational. The process then begins with the receipt of an SMS message at the call center (step 205). When the call center application server receives the SMS message, it opens an SMS session (step 210) if there is not an open SMS session associated with the sender of the SMS message. Opening the SMS session may be done in a variety of ways, but it necessarily involves creating a record so that the call center application server will be able in the future to determine if an SMS session associated with the sender of an SMS message is already open. When an SMS session is opened, an agent is assigned (step 215) to the session. When an agent has been assigned, the received SMS message is routed to the assigned agent (step 220). In this context, “routing” refers to forwarding the SMS message to a selected agent. This may mean that between its arrival at the call center application server and routing, it may have to be stored in a temporary buffer or some other location.

It should be apparent that the significance of an SMS session is that a particular SMS message sender and agent may communicate using SMS messages over an extended period of time. This avoids the shortcoming of existing systems, noted above, where SMS messages, if they are received at all, would simply be routed to the next available agent. In some cases, however, an additional agent may have to be assigned for one reason or another (not shown in FIG. 2). In fact, in some SMS sessions, this may have to be done more than once. When a reassignment occurs, the original SMS session agent (or any agent assigned between the original SMS session agent and the current agent) may continue to receive further SMS messages in the SMS session. For these reasons, an SMS session in most embodiments will be associated with a particular SMS client, rather than a combination of SMS client and call center agent. Note in this context that the term “SMS client” is used to refer to the non-call center party, who at times is also the sender of an SMS message (and so described). The SMS session remains open until closed, for example by action of the currently assigned SMS agent.

Note that, as was mentioned above, at in some situations a call center will invite a dialog with an SMS client, for example by sending text messages designed to entice the recipient to contact the call center. In this situation, it is preferred that an SMS session not be opened until an SMS message is actually receive in response to the invitation.

FIG. 3 is a flow diagram illustrating a method 300 if integrating SMS messages into the operation of a call center according to another embodiment of the present invention. At Start, it is presumed that the components necessary to performing this method are available and operational. The process then begins with the receipt of an SMS message at the call center (step 305) and, in this embodiment, specifically at a call center application server. When the SMS message is received, it is scanned (step 310) to determine the identity of the originating station. In this embodiment, the identity and time of arrival are stored in the SMS message log (step 315), and the message itself is stored in the SMS message cache (step 320). Although not maintained in all embodiments, if present, the SMS message log and the SMS message cache are both preferably located in an SMS session database in or directly accessible to the call center application server.

In the embodiment of FIG. 3, when an SMS message arrives and the identity of the originating station has been ascertained, the call center application server queries the session control log of the SMS session database to determine (step 325) whether an SMS session involving the originating station is currently in progress. If not, an SMS session is initiated (step 330) by storing the relevant information in the SMS session control log. In a preferred embodiment, the relevant information includes at least the identity of the sending party and the time the SMS message was received. The call center application server then selects an agent (step 335). In a preferred embodiment, the selection of an agent takes into account both agent availability and agent qualifications.

In general, call centers have a variety of ways of making routing decisions when incoming calls are being assigned to agents. In some implementations, SMS client history may also be taken into account, for example, by querying the SMS message log to determine whether the this particular SMS client has previously communicated with the call center using SMS messages. Any stored information regarding this previous session may of course be taken into account in selecting an agent. If there is a way to cross-reference the SMS client's identity with other types of communication, for example by telephone conversation, that information may be used to advantage as well.

In another embodiment, the received SMS message may be scanned for content also (not shown in FIG. 3). This may involve an analysis of the words used in the text, with the aim of ascertaining the reason for the sender's communication. This information is naturally useful when agents are selected, and may also in some implementations be provided to the selected agents in order to assist them in answering the communication. When available, a SMS message content analysis is typically performed prior to routing the session-initiating SMS message, so that the results of the analysis may be used in agent selection, although the analysis may be in some embodiments done at other times as well.

In the embodiment of FIG. 3, if it is determined that a session involving this SMS client is already in progress, then the identity of the session agent is retrieved (step 340) from the SMS session database. In a preferred embodiment, a determination is then made as to whether the SMS session agent is available (step 345). If so, then with few exceptions they will remain the session agent. The newest SMS message is then routed to the current session agent (step 355). If the SMS session agent is not available, then a determination is made (step 350) whether to change the session agent. This determination may be based on any of several factors, which will vary by the preference of the call center administrator and the capabilities of the call center itself.

Here it is noted that an SMS message session is not the same as a voice session with a particular agent. In a voice session, the session is typically considered to be initiated and continuously open until (one or both of) the parties hang up, when the session comes to a close. One party to the voice call may put the other on hold, but preferably this does not entail a long delay, and the session is easily rejoined. An SMS message session, on the other hand, begins when the call center application server initiates it, in most embodiments whenever a received SMS message is found not to be associated with an open session. The SMS message session may then remain open for some time as the parties send SMS messages to each other. Since the delay from one SMS message to another may actually be quite long, the agent involved, or at least the call center employing the agent, will want the agent otherwise available during long delays.

As a consequence, a session agent may be unavailable when a session-related SMS message is received in the call center application server. Given the nature of an SMS message session, however, this does not automatically mean that another agent must be chosen. In some embodiments, the session agent is queried as to whether another agent selection should be made. In addition, or instead, an approximate forecast may be made as to when the session agent will become available, and no new agent is selected if the delay is within certain limits. These limits may be pre-determined or vary according to factors such as how busy the call center is at that time, or how many messages have already been sent in the current SMS session.

In the embodiment of FIG. 3, when a determination has been made to select a new agent, then the process returns to step 335, where a new session agent is selected, and the SMS message is routed accordingly. Note that in some implementations, different agent selection criteria may be applied in this circumstance as opposed to the initial selection of an SMS message session agent, such as a bias for a more experienced agent to take over an existing session. In a preferred embodiment, whenever an SMS message is routed, each of the SMS messages preceding it in the SMS session are retrieved and sent with it, so the agent has a record of the session up to that point. In an alternate embodiment, the agent station keeps a record of each SMS message by session, then, if the session agent is not changed, it may be sufficient to simply send the SMS message for adding to the agent's record.

In the illustrated embodiment, if the SMS session agent responds to the SMS message by sending an SMS message to the SMS client, the responsive SMS message is first received at the call center application server (step 360), so that it can be recorded in the SMS message log (step 365) and saved in the SMS message cache (step 370). The SMS message is then transmitted to the SMS client (step 375).

In this fashion the interaction of the SMS client and the call center may continue for some time, with many or only a few messages being exchanged. Of course there is no requirement that the same number of messages is sent by either party, or that each SMS message is responded to by its recipient. At some point, however, the SMS session will be closed (not shown in FIG. 3). In most embodiments, this will occur when the SMS agent sends a closure message to the SMS client, via the call center application server as with all other SMS messages. In some embodiments, however, the SMS client may also be given the ability to close the SMS session, usually by transmitting an SMS message to the call center. The call center administrator will typically also have the ability to close the SMS session by communicating in some way with the call center application server.

In one embodiment (not shown), the call center application server monitors how long an SMS session has been open, and after a certain amount of elapsed time, reminds the agent that the session needs to be attended to or closed. In this embodiment, the call center application server may instead wait to send a reminder until the session has gone for a certain period of time without a message from either party. The call center application server may also send a reminder to the SMS agent if a predetermined amount of time has passed without a response to SMS message received from an SMS client. When an SMS message session is closed, in this embodiment it is recorded in the SMS message log and, if desired, the session closure message is stored in the SMS message cache. At this point the SMS session records may be dispositioned. In some embodiments, all records will be maintained for historical purposes or, in other embodiments, deleted. In yet other embodiments, some records, such as the SMS message log are retained, while the SMS message cache associated with the closed session will be deleted. Data that is retained may in some cases be moved from the SMS session database to another location.

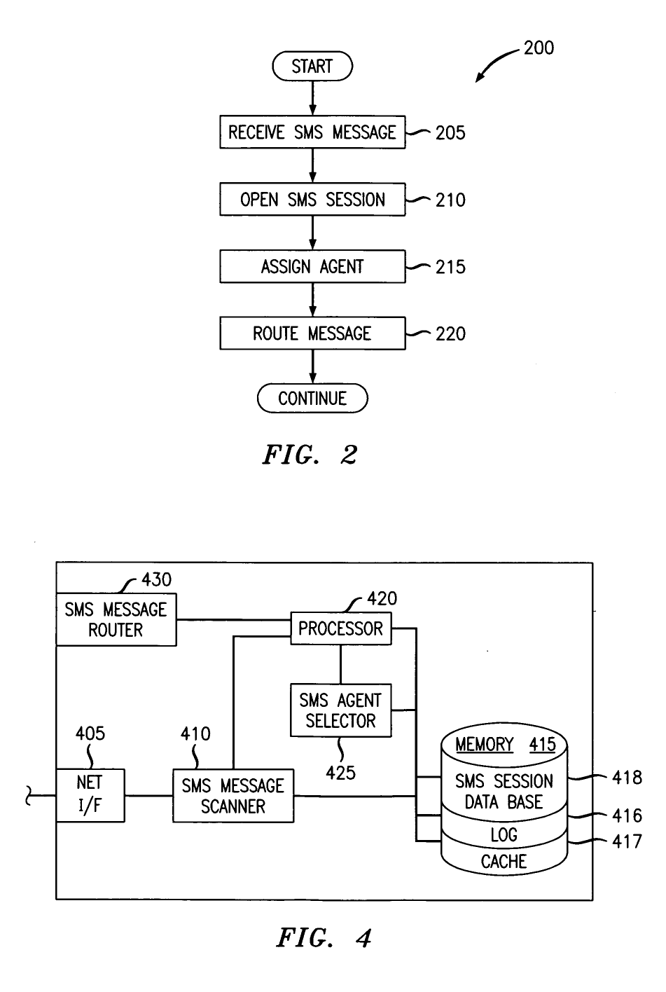

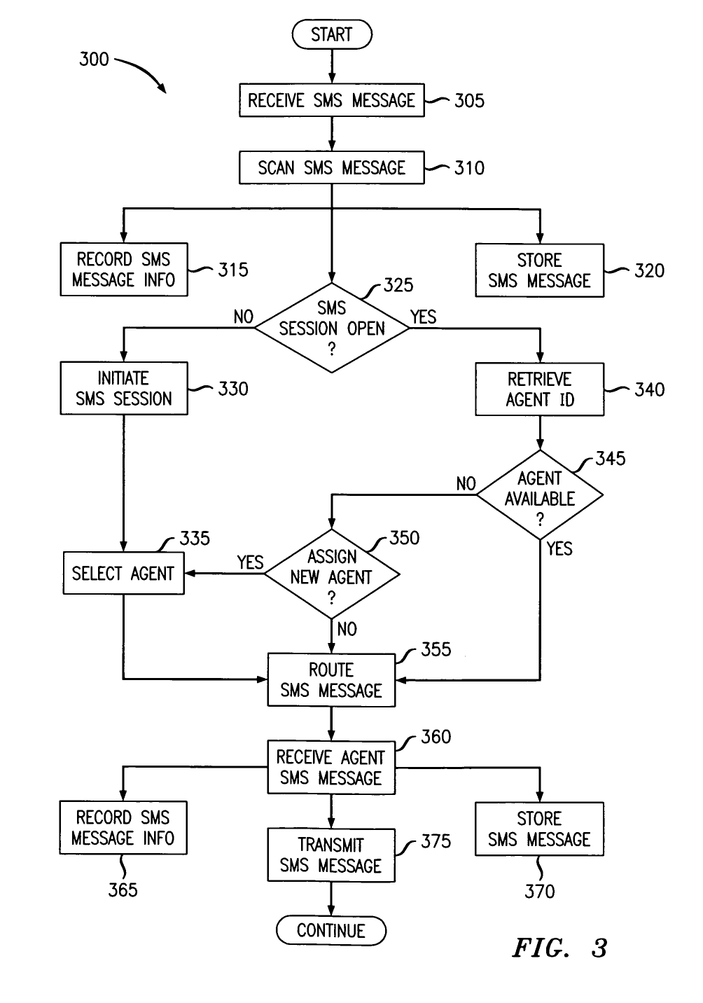

FIG. 4 is a simplified block diagram illustrating selected components of an application server 400 configured according to an embodiment of the present invention. In the embodiment of FIG. 4, the call center application server 400 comprises a network interface 405 for receiving SMS messages, which typically originate in a MS and are passed to the call center application server 400 via an SMSC of a wireless network (not shown). In this embodiment, network interface 405 is also used for transmitting SMS messages back to the MS via the wireless network. When an SMS message is received at application server 400, it is scanned by SMS message scanner 410, which is coupled to the network interface. The scan at least determines the identity of the SMS message sender.

In this embodiment, the call center application server 400 records the identity of the sender and the time at which the message arrived. A memory device 415 including an SMS session database 418 is, in this embodiment, available at call center application server 400 for this purpose. In a preferred embodiment, SMS session database 418 includes at least an SMS session log 416, where incoming and outgoing SMS messages are recorded, and an SMS message cache 417, where SMS messages in a given SMS session may be stored, either for the duration of the SMS session or longer, for example until archived.

In the embodiment of FIG. 4, call center application server 400 also includes a processor 420 for querying the SMS database 418 to determine whether an SMS session associated with the sender of a particular SMS message is currently open and, if so, identifying the current SMS session agent assigned to the open SMS session. The agent's identity may be stored, for example, in the SMS message log 416 or in some other location (not shown). If no session is open, or if for some other reason an agent needs to be assigned, an agent selector 425 is provided for selecting a current SMS session agent if there is no available current SMS session agent assigned to the SMS session. Finally, an SMS message router 430 for routing a received SMS message to the current SMS message agent is also shown. Note that the configuration and components illustrated in FIG. 4 represent an exemplary embodiment of the present invention, and in a typical implementation there will be many more components. In addition, not all of the components illustrated in FIG. 4 are required in every embodiment, and in some embodiments these components may be combined in a single unit or further divided into separate components.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A method of handling SMS communications in a call center application server, comprising:
receiving an SMS message from an SMS client in the call center application server;
identifying the sender of the received SMS message;
determining whether an SMS session associated with the sender is currently open and, if so, identifying the current SMS session agent;
if an SMS session associated with the sender is not currently open, opening an SMS session and selecting a current SMS session agent; and
routing the SMS call to the current SMS session agent.

2. The method of claim 1, further comprising closing an open SMS session.

3. The method of claim 2, wherein the SMS session is closed upon receipt of an SMS session closure message from the current agent.

4. The method of claim 2, wherein the SMS session is closed when a predetermined time has elapsed since an SMS message in the SMS session was last sent or received.

5. The method of claim 1, further comprising creating a record of the received SMS message in an SMS message log.

6. The method of claim 5, further comprising storing the received SMS message in an SMS message cache.

7. The method of claim 6, further comprising deleting the SMS messages of an SMS session stored in the SMS message cache upon closing the SMS session.

8. The method of claim 1, further comprising determining whether an identified current SMS session agent associated with an open SMS session is available when an SMS message in the session is received.

9. The method of claim 9, further comprising, if the current SMS session agent is not available when and SMS message in the SMS session is received, determining whether to select another current agent for the SMS session.

10. The method of claim 1, further comprising analyzing the content of a received SMS message.

11. The method of claim 10, wherein the selection, if any, of a current agent is a function of the analysis.

12. A call center application server, comprising:
a network interface for receiving SMS messages;
an SMS message scanner coupled to the network interface for determining the identity of an SMS message sender;
an SMS session database for storing data related to SMS message sessions;
a processor for querying the SMS database to determine whether an SMS session associated with an SMS sender is currently open and, if so, identifying the current SMS session agent assigned to the open SMS session;
an agent selector for selecting a current SMS session agent if there is no available current SMS session agent assigned to the SMS session; and
an SMS message router for routing a received SMS message to the current SMS message agent associated with the SMS sender.

13. The call center application server of claim 12, wherein the SMS session database physically resides within the call center application server.

14. The call center application server of claim 12, wherein the SMS session database comprises an SMS message log.

15. The call center application server of claim 12, SMS session database comprises an SMS message cache.

16. The call center application server of claim 12, wherein the message scanner further extracts the content of a received SMS message, and further comprising a message analyzer for analyzing the extracted content.

17. The call center application server of claim 12, further comprising agent availability determiner to determine whether an agent currently assigned to a SMS session is available.

18. A method implemented by a call center application server for integrating SMS message communication into the call center environment, comprising:
opening an SMS session upon the receipt of an SMS message if there is not an open SMS session associated with the sender of the SMS message;
assigning an agent to the SMS session when it is opened; and
routing the received SMS message to the assigned agent.

19. The method of claim 18, wherein opening an SMS session comprises recording information related to the received SMS message in an SMS message log.

20. The method of claim 19, wherein the related information comprises the identity of the SMS message sender and the assigned agent.

21. The method of claim 18, further comprising determining that a received SMS message is from a sender associated with an open SMS session.

22. The method of claim 21, further comprising retrieving the identity of the agent assigned to the open SMS session.

23. The method of claim 22, further comprising determining whether the agent assigned to an open SMS session is currently available and, if not, determining whether to assign a second agent to the SMS session.

24. The method of claim 23, wherein routing the received SMS message comprises routing the received SMS message to the second SMS agent if one is assigned.

25. The method of claim 24, wherein routing the received SMS message comprises routing the received SMS message to the SMS agent assigned when the SMS session was opened.

26. The method of claim 18, further comprising closing the open SMS session.
